(19) United States
(12) Patent Application Publication
(10) Pub. No.: US 2024/0188015 A1
(43) Pub. Date: Jun. 6, 2024

(54) METHODS AND APPARATUS FOR INTER-CELL MULTI TRP OPERATION IN WIRELESS COMMUNICATION SYSTEMS

(71) Applicant: InterDigital Patent Holdings, Inc., Wilmington, DE (US)

(72) Inventors: Virgil Comsa, Montreal (CA); Janet Stern-Berkowitz, Little Neck, NY (US); Paul Marinier, Brossard (CA); Afshin Haghighat, Ile-Bizard (CA); Moon IL Lee, Melville, NY (US); Jonghyun Park, Syosset, NY (US)

(21) Appl. No.: 18/285,165

(22) PCT Filed: Mar. 29, 2022
(86) PCT No.: PCT/US2022/022251

§ 371 Date: Sep. 29, 2023

Related U.S. Application Data
(60) Provisional application No. 63/170,122, filed on Apr. 2, 2021.
(60) Provisional application No. 63/249,197, filed on Sep. 28, 2021.

(51) Int. Cl. H04W 56/00; H04W 72/1268; H04W 76/20

(52) U.S. Cl. CPC H04W 56/0045; H04W 56/0015; H04W 72/1268; H04W 76/20

(57) ABSTRACT

Method, apparatus and systems are disclosed that may be implemented in a wireless transmit/receive unit (WTRU). In one representative method implemented in a WTRU, the WTRU may determine a first CSI report associated with a first TRP, and determine a second CSI report associated with a second TRP. A priority between the first CSI report and second CSI report may be determined. The priority (e.g., priorities of the first CSI report and second CSI report) may be based at least in part on whether inter-cell mTRP is configured. One of the first CSI report and second CSI report having a higher priority may be transmitted to a network. Other representative methods relate to blind decoding priority determination, selection of PUCCH configurations, timing advance adjustments and beam application time determination.

### FIELD OF THE INVENTION

This disclosure pertains to methods and apparatus for inter-cell multi TRP operation in wireless communication systems.

### BACKGROUND

In Rel-16, one of the NR MIMO features was multi-Transmission/Reception Point (mTRP) operation where the TRPs share the same Physical Cell Identity (PCI). As an evolution, in Rel-17, the work expanded the scope of the mTRP feature to inter-cell scenarios, where the TRPs have different PCIs.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a is a signal flow diagram illustrating an exemplary case of a dynamic indication of TCI state by a DCI and utilization of beam application time in accordance with an embodiment; and

FIG. 3 is a signal flow chart illustrating an exemplary embodiment wherein a WTRU may send separate acknowledgment signals for each of dynamically indicated TCI states.

FIG. 4 is a flow chart illustrating an example of a method implemented by a WTRU for multi-transmission reception point channel state information reporting.

### DETAILED DESCRIPTION

### 1. Introduction

In the following detailed description, numerous specific details are set forth to provide a thorough understanding of embodiments and/or examples disclosed herein. It will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### 2. Example Networks for Implementation of the Embodiments

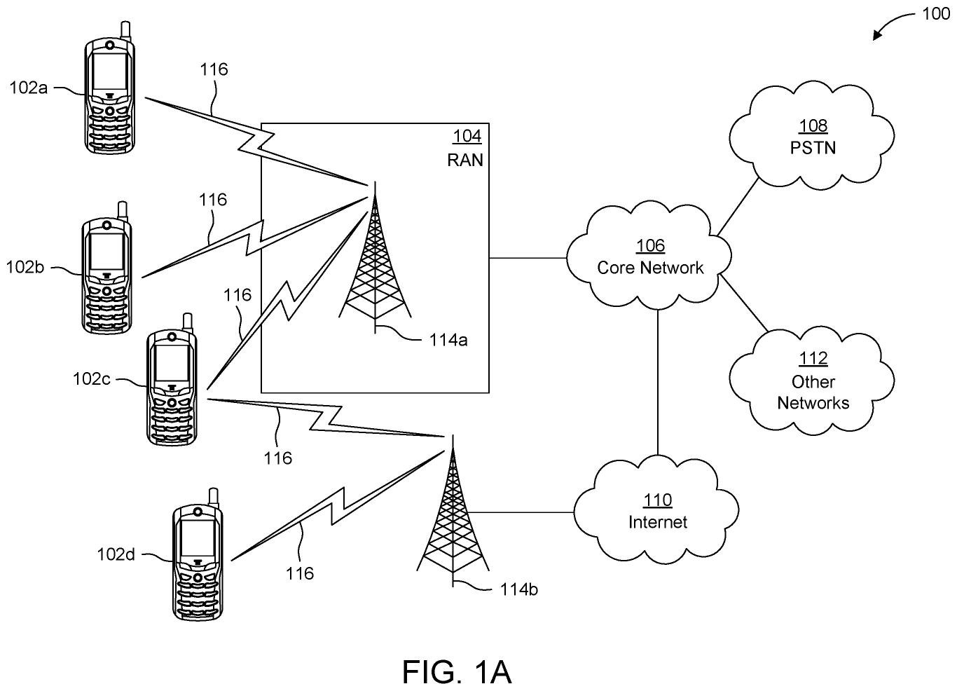

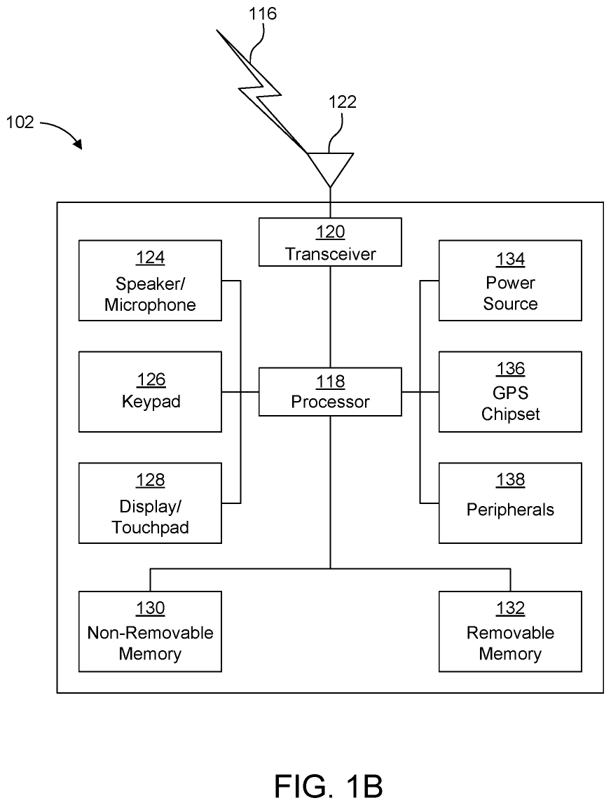

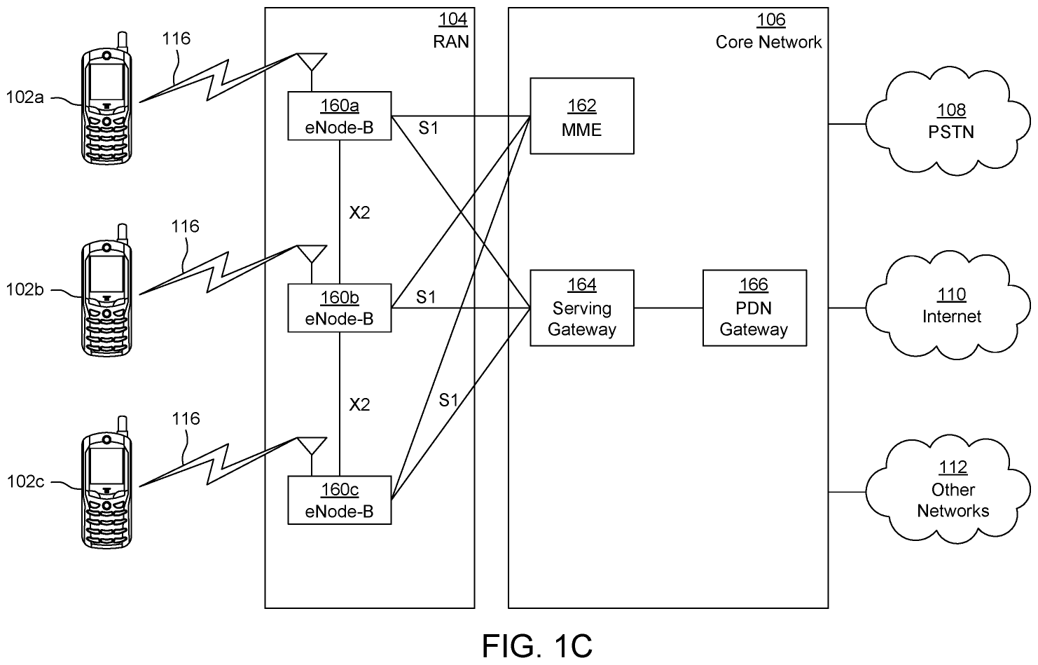

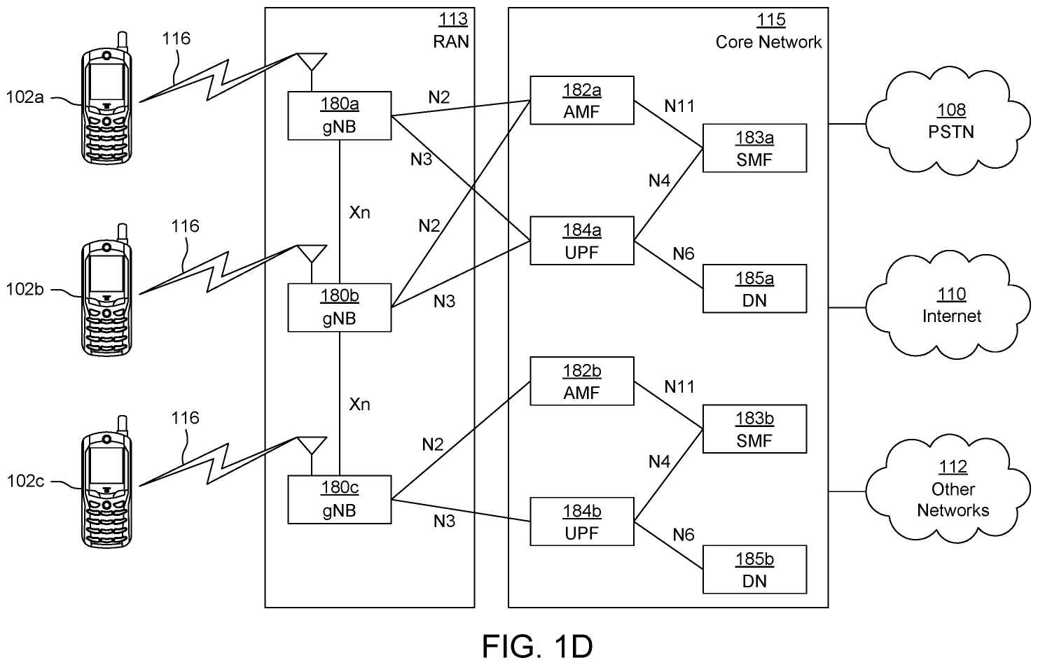

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. In one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11 af and 802.11 ah relative to those used in 802.11 n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11 n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11 ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non−3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a−b, eNode-B 160a−c, MME 162, SGW 164, PGW 166, gNB 180a−c, AMF 182a−b, UPF 184a−b, SMF 183a−b, DN 185a−b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### 3. Multi-Transmission/Reception Point (mTRP) Operation in 3GPP

As noted above, in Rel-16, one of the NR MIMO features was mTRP operation where the TRPs share the same Physical Cell Identity (PCI). As an evolution, in Rel-17, the work expanded the scope of the mTRP feature to inter-cell scenarios, where the TRPs have different PCIs.

The inter-cell mTRP operation in Rel-17 will operate under certain restraining deployment and synchronization conditions that would require certain Transmit Configuration Indication (TCI) improvements that would resolve the WTRU Quasi-Colocation (QCL) assumptions related to the second cell PCI/SSBs (Synchronization Signal Block) as the WTRU cannot distinguish the correct QCL source without a clear measurement of the SSBs that belong to the second PCI. Thus, the PCI that belongs to the second cell or an index linked to this cell identity must be present in the TCI for the correct QCL assumptions.

The measurements configuration will be adjusted so the WTRU will provide the gNB with the right candidate as a second inter-cell mTRP. These measurements include the best beams. Upon reception of the non-serving cell candidates, the base station may decide to configure the WTRU for inter-cell mTRP operation.

In terms of deployment scenario, the basic Rel-17 assumptions for inter-cell mTRP operation are:
the reception of the secondary TRP is within a (Cyclic Prefix) CP for all Sub-Carrier Spacings (SCSs)
Both cells have the same central frequency
The bandwidth of the cells is the same or at least for the SSBs
All the Rel-16 mTRP scenarios work, including multi-DCI (Downlink Control Information) (scheduling from 2 cells)
Ideal backhaul

It can be seen from the above basic assumptions that there will be certain limitations to the deployments of inter-cell mTRP operation due to synchronization requirements. The current minimum requirement for cell phase synchronization accuracy is 3 us. Considering the SCS choices versus corresponding symbol and CP length against cell phase synchronization requirement, reveals that the deployments may be limited to 15 KHz SCS at most, and that the cells must be very well synchronized.

The inter-cell mTRP feature is part of a larger NR MIMO and beam management improvement plan where a unified TCI framework is about to be developed as well. The concepts presented here are in the context of the new unified TCI framework.

In inter-cell mTRP context, when the synchronization of the cells is not tight enough (not within a cyclic prefix) or the receive time difference between cells is beyond a cyclic prefix, the WTRU may be required to acquire the UL synchronization. One of the mechanisms to acquire the uplink synchronization is the random access procedure.

Channel State Information (CSI) Priorities Under Inter-Cell mTRP Scenario

Under inter-cell mTRP scenario, the WTRU may still work under a single cell assumption in terms of reception bandwidth, while it must distinguish between its respective cells' feedback reports and their priorities.

The Channel State Information (CSI) report for the serving cell may be more important than reporting the measurement corresponding to the TRP associated with the non-serving cell. Moreover, in certain scenarios, when carrier aggregation (CA) or dual connectivity (DC) is configured for the WTRU where one of the cells may be configured for mTRP operation, the CSI priority function would require extra parameters for proper evaluation, that may depend on scenario and purpose (e.g. physical layer inter-cell mobility).

### Pucch Configurations Selection

Under the inter-cell mTRP deployment, the WTRU may receive multiple Physical Unlink Control Channel (PUCCH) configurations with certain priorities that are associated with resources, and/or power control parameters. It is expected that the WTRU supporting such operation will; be able to correctly select the appropriate configuration for each particular situation.

TA Adjustment when the Cells are not within a Cyclic Prefix Synchronization or Asynchronous

A WTRU may perform a random access procedure, for example, in order to obtain a timing advance (TA) or timing advance adjustment. The random access procedure may include at least one of a preamble transmission and a response reception, such as random access response reception. For example, the WTRU may transmit a preamble (e.g., a random access preamble). The preamble may be transmitted on (or using) time and/or frequency resources that may be physical random access channel (PRACH) resources. The WTRU may receive a response such as a random access response (RAR) after transmitting the preamble. The preamble transmission may be to a gNB. The RAR may be received from the gNB. The RAR may include a TA (e.g., a TA value) or a TA adjustment (e.g., a TA adjustment value). The WTRU may use the TA or TA adjustment to adjust its UL timing or transmission of a channel or signal such as a physical uplink shared channel (PUSCH), a physical uplink control channel (PUCCH), and/or an SRS.

The WTRU may determine a TA from its current TA and a TA adjustment. The WTRU may add (or subtract) a TA adjustment from its current TA to obtain a new or updated TA. For example, TA=current (or old) TA+TA adjustment plus, optionally, one or more other values or parameters.

A WTRU may receive a request, e.g., from a gNB, to perform a random access procedure and/or transmit a preamble. The request may be provided and/or received in a Physical Downlink Control Channel (PDCCH) that may be referred to as a PDCCH order. The WTRU may transmit a preamble in response to receiving a PDCCH, such as a PDCCH order.

A PDCCH that may be used to request a preamble transmission, e.g., for a random access procedure, may include at least one of:
a preamble index (e.g., that identifies which preamble from a set of preambles)
an indication of one or more PRACH resources or RACH occasions
a PRACH Mask index that may indicate a RACH occasion
a Search Space or Physical Broadcast Channel (SS/PBCH) index that may be used to indicate the RACH occasion for the PRACH (e.g., preamble) transmission
an UL/SUL (Supplemental Uplink) indicator that may indicate which UL carrier to use for the transmission (e.g., normal UL or supplemental UL carrier).

A WTRU may communicate with multiple TRPs simultaneously or in a Time Division Multiplex (TDM) manner. The TRPs may be identified by at least one of an identifier (ID), such as a cell identifier (ID) or physical cell ID, and/or a beam indication. A beam indication may be in the form of a TCI (transmission configuration indication) state, SS/PBCH indication or index, and/or a Channel State Information-Reference Signal (CSI-RS) indication or index. A TCI state may correspond to a SS/PBCH indication or index, and/or a CSI-RS indication or index. One TRP may be considered as or include a serving cell or default cell. The other may be considered as or include a non-serving cell or non-default cell. One TRP may be considered as or include the normal serving cell and the other may be considered as or include a supplemental serving cell.

### Beam Application Time

It is known that between a beam indication and the exact moment of the beam operational phase there is a time interval called beam application time. Under an mTRP inter-cell deployment with multi-DCI or single DCI reception, the beam application time and the procedures for its determination may have to be defined in detail.

### Control Resource Sets (CORESETs), Search Spaces (SSs), Blind Decoding Limits

A WTRU may be configured with one or more CORESETs, wherein a CORESET may be configured or associated with a CORESET index (e.g., number). A CORESET configuration may include or identify frequency information, such as frequency resources (e.g., RBs) for the CORESET. A CORESET configuration may include the duration of the CORESET (e.g., in symbols, such as consecutive symbols).

A WTRU may be configured with one or more search spaces (SSs) where a SS may be configured or associated with a SS index (e.g., number). A SS may be a SS set. The term SS may be used interchangeably herein with the term SS set.

A SS configuration may identify a CORESET associated with the SS. The frequency resources in which to monitor PDCCH candidates in the SS may be the frequency resources configured for the associated CORESET. A SS configuration may include a configuration of time resources for monitoring the SS. The configuration of the time resources may include configuration of at least one of: a periodicity (e.g., a slot periodicity), an offset (e.g., an offset or symbol offset from the start of a slot), and a duration (e.g., in slots).

A WTRU may monitor for one or more PDCCH candidates (e.g., for PDCCH in one or more PDCCH candidates) in a SS according to the configured timing, for example, according to one or more of (e.g., all of) the configured SS periodicity, SS offset, SS duration, and CORESET duration. The WTRU may monitor for one or more PDCCH candidates in a SS in the configured CORESET frequency resources and/or for the CORESET duration for the associated CORESET.

A PDCCH candidate may comprise a set of control channel elements (CCEs). A PDCCH candidate may have or correspond to an aggregation level (AL), such as an aggregation level of CCEs. For example, an aggregation level of 4 may correspond to the aggregation of 4 CCEs. A SS configuration may include configuration of a number of PDCCH candidates to monitor for each of one or more aggregation levels, for example w candidates for AL x, and y candidates for AL z.

A WTRU may be configured with a plurality of SSs. A WTRU may be configured, e.g., based on SS timing, to monitor for PDCCH candidates in multiple SSs in a span, such as a slot. Since monitoring for PDCCH candidates, which may be referred to as blind decoding, may consume power, the number of PDCCH candidates to monitor in a span may be limited.

A WTRU may have one or more limits or maximums related to the amount of blind decoding it performs (or is required to perform) in a span or slot. A span may be a time span. A span may be or may correspond to a number (e.g., one or more) of symbols or slots.

The limits or maximums may include at least one of a maximum number of PDCCH candidates and/or a maximum number of CCEs that the WTRU may monitor and/or receive or attempt to receive in a span. There may be a maximum number of PDCCH candidates per serving cell. There may be a maximum number of CCEs (e.g., per serving cell) such as a maximum number of non-overlapping CCEs (e.g., per serving cell). CCEs corresponding to PDCCH candidates may be overlapping or non-overlapping.

A WTRU may be configured to monitor a plurality of PDCCH candidates in a span where the PDCCH candidates may correspond to one or more SSs. When the number of PDCCH candidates in the plurality exceeds a maximum number of PDCCH candidates and/or the number of CCEs (e.g., non-overlapping CCE) in the plurality of PDCCH candidates exceeds a maximum number of CCEs (e.g., non-overlapping CCEs), the WTRU determines to monitor a subset of the plurality of PDCCH candidates.

The WTRU may determine the subset of PDCCH candidates to monitor based on the priority of the SSs and/or the PDCCH candidates. PDCCH candidates in higher priority SSs may have higher priority than PDCCH candidates in lower priority SSs. Common SS may have higher priority than WTRU-specific SS. A SS (e.g., WTRU specific SSs) with a lower (or higher) index may have a higher priority than a SS (e.g., WTRU-specific SS) with a higher (or lower) index. Other prioritizations may also apply, such as related to the serving cells. For example, WTRU-specific SS PDCCH candidates on the primary serving cell may have higher priority than WTRU-specific SS PDCCH candidates on a secondary cell.

The WTRU may determine the subset of candidates to monitor by allocating candidates according to SS priority until a maximum is reached. Once the maximum is reached, the WTRU may stop allocating candidates. The WTRU may monitor (e.g., only monitor) the candidates in the subset. The allocation process may result in monitoring a subset of candidates in a SS. Within a SS, PDCCH candidates may be prioritized (e.g., based on candidate number).

### 4. Subjects to be Addressed with Respect to mTRP

The innovations planned for mTRP by 3GPP present several issues that require solution, and that will be addressed in the following sections.

4.1 CSI Reporting Priorities for Inter-Cell mTRP

In the mTRP inter-cell scenario, the WTRU receives RSs and control and data information from two cells with different PCIs. This is like a carrier aggregation scenario in many respects, but different because the cells are fully overlapping. It is not clear if a carrier aggregation framework would be adopted since that would create some issues on its own. The second TRP may be associated with a non-serving cell and may be indicated via a cell index in a configuration that may be associated with the second PCI. This index may be associated with a second PCI that can be present in a TCI state. Alternatively, this index may be linked to an associated group of TCI states that are linked to a different PCI. Alternatively, this index may be linked to a group of RSs that belong to a specific cell indicated through TCI states. In more general terms, the choice of index value, for example between 0 or 1 may be based on a direct association with a PCID, another information element, or a form of implicit/explicit grouping. For example, one or more of the following may be used determine the index value: 1) The PCI indicated/associated in the TCI state, 2) a flag indicating whether a TCI state/QCL information is associated with a serving or non-serving cell, 3) explicit or implicit grouping of TCI states associated with serving or non-serving cell, 4) a set of RS indices corresponding to TCI state/QCL-Info of serving or non-serving cell, and 5) a set of RS indices corresponding to TCI state/QCL-Info of serving or non-serving cell.

In this situation, the WTRU would still work under a single cell assumption in terms or reception bandwidth, while it must make a distinction between its respective cells' feedback reports and their priorities. The CSI report for the serving cell is more important than reporting the measurement corresponding to the TRP associated with the non-serving cell. Moreover, in certain scenarios, when carrier aggregation (CA) or dual connectivity (DC) is configured for the WTRU, where one of the cells may be configured for mTRP operation, the CSI priority function would require extra parameters for proper evaluation.

Rel-16 CSI report priority has the following format:

CSI reports are associated with a priority value, Priics/, wherein

Pri_{iCSI}(y,k,c,s)=2·N_{cells}·Mₛ·y+N_{cells}·Mₛ·k+Mₛ·c+s where
y=0 for aperiodic CSI reports to be carried on PUSCH, y=1 for semi-persistent CSI reports to be carried on PUSCH, y=2 for semi-persistent CSI reports to be carried on PUCCH, and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
s is the reportConfiglD and Mₛ the value of the higher layer parameter maxNrofCSI-ReportConfigurations.

A first CSI report is said to have priority over a second CSI report if the associated Pri_{iCSI}(y,k,c,s) value is lower for the first report than for the second report.

### 4.2 Blind Decoding Priority Determination

How the WTRU determines the subset of PDCCH candidates to monitor when repeated PDCCHs or linked SSs occur in the same span (e.g., time span or slot) should be determined.

4.3 PUCCH Configurations and PC Parameters Selection from Both TCI State and PHY Priority

PUCCH may have different configurations configured with different priorities. The problem is related to selection of the resources and the PC parameters in the context of inter-cell mTRP, PHY priorities, and TCI state.

4.4 Timing Advance Adjustment when Adding an Async Second Cell Under Inter-Cell mTRP Operation

When adding an async cell at the beam level in the mTRP operation mode, before transmitting, the WTRU may have to adjust its TA. The WTRU may use (or need to use) separate or different TA for the first TRP and the second TRP. A means should be provided to determine or obtain the TA for the second TRP.

### 4.5 Beam Application Time

The beam application time for an indicated TCI is referred to the time elapsed from a time reference point known to both the gNB and the WTRU (e.g., the last symbol of the transmitted acknowledgment signal) to the time of application of the new TCI state. A mechanism should be provided for ensuring the correct determination of the beam application time so that the gNB and the WTRU start operating when both entities have the correct beam(s) setup in place and are ready.

### 4.6 PCI and CORESET Pool Index (CORESETPoolIndex)

The Rel-16 multi TRP (mTRP) configuration supports intra-cell mTRPs that are all under the same cell PCI and multi Downlink Control Information (mDCI) transmissions for PDCCH. Rel-16 specifies a maximum number of two RRC configurable CORESETPoolIndexes values, namely, a “0” (CORESETPoolIndex=0) and a “1” (CORESETPoolIndex=1). In Rel-16, one CORESETPoolIndex value is reserved for a serving cell from which control plane configuration information is transmitted towards a UE (and/or received by the UE). Another CORESETPoolIndex value is reserved for one or more non-serving intra-cell mTRPs.

In Rel-17 mTRP evolved to include inter-cell mTRP configuration/operation, introducing operation with cells having different PCIs. It has been agreed to have the TCI configured with an index or indicator that differentiates the second PCI cell related TCI states from the TCI states for the serving cell.

Switching between intra-cell mTRP and inter-cell mTRP may occur dynamically and both inter-cell mTRP and intra-cell mTRP may be configured simultaneously. A problem may arise when switching between intra-cell mTRP and inter-cell mTRP if both inter-cell mTRP and intra-cell mTRP are configured simultaneously due to ambiguity in assignment of CORESETPoolIndexes. The UE must discriminate which mTRP has the CORESETPoolIndex 1 while the CORESETPoolIndex 0 is for serving cell. There is a need for a mechanism to enable a WTRU/UE to decode information of PDCCH transmissions received from the TRP under the correct QCL assumption. As used herein, the terms ‘a PDCCH transmission’ comprise a transmission comprising information may be associated with downlink control channel.

### 5. mTRP Improvements and Solutions

In the following discussion, the term serving cell refers to the anchor cell the WTRU is in Connected Mode with in the gNB before adding a second TRP; Non-Serving Cell refers to the candidate TRP or the second TRP added to the mTRP inter-cell configuration, having a different PCI (Physical Cell Identity); PCell refers to the primary cell under CA scenario or DC scenario in a Master Cell Group (MCG); and PSCell refers to the primary cell on a Secondary Cell Group (SCG) under DC scenario.

5.1 CSI Reporting Priorities Determination for Inter-Cell mTRP Solutions

If the WTRU is configured with a single cell index for both inter-cell TRPs then, when (a) the CSI feedback is said to collide (meaning that the WTRU is required to report two or more different reports) and (b) the uplink resources/physical channels are overlapping in one or more symbols, the WTRU is supposed to compute the CSI priority function output for each hypothetical CSI report and send only the one that is associated with the lowest output value of the CSI priority function.

The current function format is:

Pri_{iCSI}(y,k,c,s)=2·N_{cells}·Mₛ·y+N_{cells}·Mₛ·k+Mₛ·c+s where
y=0 for aperiodic CSI reports to be carried on PUSCH, y=1 for semi-persistent CSI reports to be carried on PUSCH, y=2 for semi-persistent CSI reports to be carried on PUCCH, and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
s is the reportConfiglD and Mₛ the value of the higher layer parameter maxNrofCSI-ReportConfigurations.
   Addition of an Extra Index ‘t’ to the Priority Function

There are four variables to consider, (y, k, c, s). Since it is assumed that the cell index remains the same for the cell that will have two overlapping TRPs with different PCIs; to distinguish them in the CSI report priority computation context, a new indicator (herein termed “t”) is added.

Thus, in this embodiment, the CSI priority function is extended to five parameters, i.e., Pri_{iCSI}(y, k, c,s, t).

In one such embodiment, the Pri_{iCSI}(y, k, c, s) when the WTRU is configured with a single serving cell and a second TRP with different PCI (named here non-serving cell), may take the following format:

Pri_{iCSI}(y,k,c,s,t)=2·N_{cells}·Mₛ·y+N_{cells}·Mₛ·k+Mₛ·(c+t)+s,

where all the existing parameters remain the same while index t is added to the serving cell index as shown in the above equation and:
t=0 for the serving cell and t=1 for the non-serving cell when the inter-cell mTRP is configured, otherwise t=0.

In an embodiment, the equation may take the following format:

Pri_{iCSI}(y,k,c,s,t)=2·N_{cells}·Mₛ·y+N_{cells}·Mₛ·k+Mₛ·c+s+t

where all the parameters remain the same, while index t is added as shown in the above equation and:
t=0 for the serving cell and t=1 for the non-serving cell when the inter-cell mTRP is configured, otherwise t=0.

Power sharing of WTRU may be considered in the context of inter-cell mTRP configuration, e.g., for coexistence reasons. The WTRU power may be bounded by its power class and the related power reductions that are linked to the Resource Block (RB) allocation, modulation, and other possible additional power reductions (Maximum Permissible Exposure (MPE), Specific Absorption Rate (SAR) or Additional Maximum Power Reduction (A-MPR)).

In an embodiment, when the uplink transmissions in the serving and non-serving cell channels are overlapping in at least one symbol, the applicable power reduction parameters and rules between the two cells may be:
WTRU may apply the higher MPR between the two transmissions when the RB allocations are perfectly overlapping. Alternatively, if the RB allocations do not overlap, a new MPR value may be derived for the global RB allocation mapping that includes both uplinks transmissions and accounts for the higher modulation order and RB mapping.
The A-MPR may account for the entire RB allocation between the two UL transmissions as the RB allocations may differ. Thus, the WTRU has to account for all RBs allocated between cells. For example, A-MPR1 linked to serving cell is related to RB1 allocation. A-MPR2 linked to serving cell is related to RB2 allocation. If the RB1 and RB2 are not overlapping, a new A-MPR3 is applicable and has to be determined, for a non-contiguous global RB allocation. Thus, global RB allocation for the overlapping UL transmissions and the higher modulation order may return the final A-MPR applicable value.
If Power Management Maximum Power Reduction (P-MPR) is required for SAR/MPE effects, then it will apply for the sum of the allocated power of the uplinks.

After the WTRU determines the power for each UL channel RB allocation for the inter-cell mTRP cells transmissions, and it is determined that power scaling is required, and if CSI measurement are to be transmitted and will overlap in the time domain, the following procedure may be applied:
the WTRU determines the CSI priority according to the CSI extended priority function, including the new “t” parameter.
After determining which CSI report is transmitted and which one is dropped, and it is determined that power scaling is still required for the CSI carried transmission, the WTRU may drop entirely the transmission on the cell where the CSI report was dropped.

### Prioritization of the CSI Reports in the CA and DC Scenarios for Inter-Cell L1 Mobility on PSCell

A scenario to account for is the inter-cell physical layer mobility, as inter-cell mTRP can be an operational step in seamlessly changing a cell. This is important when the inter-cell mTRP configuration is part of carrier aggregation (CA) or dual connectivity (DC) under PSCell (Primary Secondary Cell). A secondary cell, due to its cell index, has naturally a lower priority when calculating its CSI report priority in case of reports collision. This may impact the L1_RSRP or L1_SINR measurements reports for a secondary cell. This may be a problem when the physical layer mobility/cell related measurements are reported for this secondary cell.

To address the above described scenario, and prioritize the physical layer mobility scenarios or mTRP related CSI for a PSCell under an mTRP configuration, in case of overlapping CSI reports between PCell and PSCell, the WTRU may use an extra parameter “m” for determining the CSI priority output function, when the mobility measurements are configured for PSCell and/or the mTRP inter-cell configuration belongs to a cell index c>0.

In this case the WTRU may use the following extended equation:

Pri_{iCSI}(y,k,c,s,t,m)=2·N_{cells}·Mₛ·y+N_{cells}·Mₛ·k+Mₛ·c·m+s+t

where m=0 when mTRP inter-cell is configured and c>0, otherwise m=1.
Power Control Parameters Rules in the CA and DC Scenarios when Inter-Cell mTRP is Configured

In terms of power control, for the CA and DC cases, the mTRP inter-cell configuration may use the power reduction parameters (MPR, A-MPR described above) as if the mTRP inter-cell configuration were a single common cell in combination with the parameters on the other configured cells, following the current rules in 3GPP for intra-band or inter-band combinations. In other words, when mTRP inter-cell is configured for a cell that is part of a CA or DC scenario, the power reduction parameters applicable rules described in the previous paragraph [00110] may be used.

For the carrier configured with inter-cell mTRP:

P_{CMAX_L,f,c}≤P_{CMAX,f,c}≤P_{CMAX_H,f,c} with

P_{CMAX_L,f,c}=MIN{P_{EMAX,c}−ΔT_{c,c},(P_{PowerClass}−ΔP_{PowerClass})−MAX(MAX(MPR_{c}+ΔMPR_{c},A−MPR)+ΔT_{IB,c}+ΔT_{C,c}+ΔT_{RxSRS},P−MPR_{c})}

P_{CMAX_H,f,c}=MIN{P_{EMAX,c},P_{PowerClass}−ΔP_{PowerClass}}
where
   the WTRU may apply the higher MPR between the two transmissions when RB allocations are perfectly overlapping. Alternatively, if the RB allocations do not overlap, a new MPR value may be derived for the global RB allocation mapping that includes both uplink transmissions and accounts for the higher modulation order and RB mapping.
   A-MPR_{c} is related to the total RB allocation as a collection of both transmissions under the same channel
   P_{EMAX,c} is the minimum value of the P-max signalled by each cell in the mTRP configuration

The rest of the parameters may be considered as in the current interpretation for single cell.

With the above rules for the mTRP transmissions and parameters selection rules, the CA and DC requirements may use the above parameters as a single cell in the determination of the maximum configured power per cell per carrier combination or configuration.

### 5.2 Blind Decoding Priorities Determination

PDCCH monitoring for Multi-TRP, Repeated PDCCH, or Linked SSs

How a WTRU may determine the subset of PDCCH candidates to monitor when repeated PDCCHs or linked SSs occur in the same span (e.g., time span or slot) is described herein.

PDCCH may be repeated, for example, in a multi-TRP scenario. For instance, TRP1 may be a serving TRP or a normal TRP. TRP2 may be a supplemental or non-serving TRP. For repeated PDCCH, there may be linked (or associated) CORESETs and/or linked (or associated) SSs.

In an embodiment, a first CORESET, e.g., CORESET c1, may be linked with a second CORESET, e.g., CORESET c2. CORESET c1 may be a normal, primary, or serving CORESET and may correspond to TRP1. CORESET c2 may be a supplemental, secondary, non-serving, or linked CORESET and may correspond to TRP2.

In another example, a first SS, e.g., SS s1, may be linked with a second SS, e.g., SS s2. SS s1 may be a normal, primary, or serving SS and may correspond to TRP1. SS s2 may be a supplemental, secondary, non-serving, or linked SS and may correspond to TRP2.

CORESETs c1 and c2 may have the same or different frequency resources. CORESETs c1 and c2 may have different beam indications or TCI states. The PDCCH candidates transmitted in SS s1 may be repeated in SS s2. The timing for SS s1 and SS s2 may be the same or different. For example, SS s1 and SS s2 may be in different symbols of the same slot or in different slots.

The terms supplemental, secondary, non-serving and linked may be used interchangeably herein. Normal, primary, and serving may be used interchangeably herein.

In an embodiment, CORESET c1 may have a CORESET index. CORESET c2 may have its own CORESET index or a linked CORESET index. CORESET c2 may be considered to have the same CORESET index as CORESET c1.

SS s1 may have a SS index. SS s2 may have its own SS index or a linked SS index. SS s2 may be considered to have the same SS index as SS s1.

When the WTRU determines the PDCCH candidates (e.g., the subset of PDCCH candidates) to monitor in a span (e.g., not to exceed one or more maximums), linked search spaces (e.g., in the span) may be treated like normal SSs or differently from normal SSs.

For example, when using SS index to determine relative priority among SSs, the WTRU may treat the indices of the linked SSs the same as the indices of normal SSs. The values of the normal SS indices may be non-overlapping with the values of the linked SSs.

In another example, the WTRU may determine the priority of a linked SS based on the priority of the normal SS to which it is linked. For instance, a linked SS may have the next highest priority after the normal SS to which it is linked. In more general terms, the priority of one SS may be determined based on the priority of another SS.

Whether linked SSs are treated like normal SSs or their priority is based on the priority of the normal SSs to which they are linked may be based on a configuration, which may be received from a gNB.

A linked SS may be Frequency Division Multiplexed (FDMed) (e.g., different RBs) or Time Division Multiplexed (TDMed) (e.g., different symbols) with the normal SS to which it is linked (e.g., its normal SS).

The priority of a linked SS may be determined (e.g., by the WTRU) based on whether the linked SS is FDMed or TDMed with its normal SS (e.g., the SS to which it is linked). An FDMed linked SS may have higher priority than a TDMed linked SS. For example, a WTRU may consider an FDMed linked SS to have the next highest priority after its normal SS. A WTRU may consider a TDMed linked SS to have lower priority than one or more (e.g., all) normal SSs (e.g., for a serving cell).

Linked SS may have lowest priority. A WTRU may consider normal SSs (e.g., for a serving cell) before linked SSs (for the serving cell) when determining the subset of PDCCH candidates to monitor. The order in which the linked SSs are considered may be the same order in which their linked normal SSs are considered (e.g., based on the SS indices of their normal SSs). The order in which the linked SSs are considered may be based on the SS (or linked SS) indices configured for the linked SS. Lowest index to highest index may correspond to highest priority to lowest priority (or vice versa).

A linked SS may be configured with a priority indication or a priority. The priority indication may indicate whether to consider the linked SS to have the same priority as its normal SS (or next highest priority after its normal SS). The priority indication may indicate the priority of the linked SS with respect to other linked SSs.

When a normal SS has a linked SS, the PDCCH candidates in the normal SS may be repeated in the linked SS. For a given PDCCH candidate in a normal SS, the corresponding candidate may be referred to as a repeated or linked candidate.

When determining the PDCCH candidates in a span to include in the subset to monitor, a PDCCH candidate (e.g., a normal PDCCH candidate) that is repeated in a linked SS in the span may be counted (e.g., by the WTRU) as two PDCCH candidates toward the maximum number of candidates. The CCEs counted for the PDCCH candidate (e.g., the number of CCEs not overlapping with previously counted CCEs) may be counted twice toward the maximum number of non-overlapping CCEs. The CCEs counted for the PDCCH candidate may include the CCEs (e.g., non-overlapping CCEs) for the normal PDCCH candidate and the CCEs (e.g., the non-overlapping CCEs) for the linked PDCCH candidate. There may be more than one repetition. When there is more than one repetition in the span, the counting of candidates and/or CCEs may be extended to account for all the repetitions in the span.

When all the PDCCH candidates in a SS and its linked SS cannot be included in the monitoring subset (e.g., due to reaching a maximum), one or more of the following may apply:
If all the PDCCH candidates for the normal SS can be included, the WTRU may include all the PDCCH candidates for the normal SS and then as many as it can for the linked SS without exceeding the maximum
The WTRU may include an equal number of PDCCH candidates from the normal and linked SSs until both cannot be included and then the WTRU may add additional normal SS PDCCH candidates until no more can be added without exceeding the maximum.

When configured with linked SSs, the WTRU may modify (e.g., increase or decrease) one or more of its maximums for a span based on the linked SSs in the span. How much the WTRU increases (or decreases) a maximum may be based on WTRU capability.

A WTRU may be configured with a PDCCH candidate maximum and/or CCE maximum to use when configured with PDCCH repetition, linked SSs, linked CORESTs, or multi-TRP operation. The configured maximums may be separate or different from the maximums to use when not configured with PDCCH repetition, linked SSs, linked CORESETs, or multi-TRP operation.

### 5.3 PUCCH Configurations and PC Parameters Selection

The embodiments described in this section may enable the WTRU to support transmission of PUCCH with more than one priority index when the WTRU sets its spatial filter for PUCCH using an enhanced TCI state. Embodiments will be described for two priority indexes (0 and 1) but may be extended to more than two priority indexes without loss of generality.

In an embodiment, the WTRU may receive, for each of at least one enhanced TCI state, a configuration of first and second sets of power control parameters for PUCCH applicable to priority index 0 and priority index 1, respectively. A set of power control parameters may include at least one of:
An identity of a serving cell (e.g., PCI or an index associated with the cell PCI)
An indication of a reference signal used as path loss reference, such as SSB, SRS or CSI-RS. Optionally, the indication of reference signal used as path loss reference may be omitted. In such case, such reference signal may correspond to a reference signal configured as part of the enhanced TCI state
A power offset parameter P0-PUCCH
An index to a closed loop adjustment
For at least one PUCCH format, an adjustment parameter.

In an embodiment, the WTRU may receive, for each of at least one enhanced TCI state, a configuration of first and second PUCCH configurations applicable to priority index 0 and 1, respectively, wherein each PUCCH configuration may include all or a subset of the parameters that may be included in the existing system for a PUCCH configuration. This may include, in addition to power control parameters, resources and resource sets for PUCCH, resources for scheduling request, parameters specific to each PUCCH format, resources for multi-CSI reporting, sets of PDSCH-to-HARQ-ACK delay parameters, resources for SPS HARQ-ACK, etc.

When transmitting PUCCH, the WTRU may first identify an enhanced TCI state applicable to the PUCCH and a priority index applicable to PUCCH. The WTRU may identify the enhanced TCI state applicable to PUCCH based on at least one of the following solutions:
Receiving MAC CE signaling and/or RRC configuration associating a PUCCH resource, CSI resource, or SR resource configuration with an enhanced TCI state;
Based on the enhanced TCI state used for transmission of an associated PDSCH (e.g. in case of HARQ-ACK);
Receiving an explicit or implicit indication in a DCI associated with the PUCCH;
Based on a property of the PDCCH carrying the DCI associated with the PUCCH (e.g. CORESET, search space, RNTI, DCI size, DCI format)
Based on a property of a PDSCH assignment associated with the PUCCH;
Receiving a group-common DCI indicating association between PUCCH and enhanced TCI state for at least one time period;

The WTRU may utilize an existing solution for determining a priority index applicable to PUCCH, such as receiving a priority indicator in the DCI associated to a HARQ-ACK for a dynamic grant. The WTRU may set its PUCCH spatial filter based on a reference signal configured as part of the identified enhanced TCI state. The WTRU may further set the power of this PUCCH based on the first or second set of power control parameters for PUCCH configured for the identified enhanced TCI state, if the determined priority index is 0 or 1 respectively.

In an embodiment, the WTRU may receive a single set of PUCCH power control parameters or a single PUCCH configuration for an enhanced TCI state. The WTRU may receive two sets of enhanced TCI states, wherein the first and second sets may correspond to priority index 0 and 1, respectively. The WTRU may determine an applicable enhanced TCI state for PUCCH by determining a priority index for PUCCH and then by selecting the first or second set of enhanced TCI states if the priority index is 0 or 1, respectively. The WTRU further may determine an enhanced TCI state from the selected set based on an embodiment such as already described (MAC CE, RRC, DCI, etc.)

5.4 Timing Advance Adjustment when Adding an Async Second Cell Under Inter-Cell mTRP Operation Solutions

### TRP TA Using PDCCH Order

The WTRU may receive a request to perform a random access that may indicate that the request is for a first TRP or a second TRP. The request to perform a random access may be received in a PDCCH, such as a PDCCH order.

The WTRU may receive a request to perform a random access that may include an indication (e.g., a single bit indication) to indicate whether the request is for a first TRP (e.g., the serving or normal TRP) or a second TRP (e.g., the non-serving or supplemental TRP). The indication may be or may include an ID or a beam indication. The WTRU may determine the TRP for which the request is received based on the indication.

In response to the request, the WTRU may transmit a preamble. The preamble may be transmitted in or using PRACH resources and/or a RACH occasion wherein the PRACH resources and/or RACH occasion may be associated with an SS/PBCH block index received with the request and/or based on a PRACH Mask index received in the request. The WTRU may use the same or different preambles, PRACH resources, and/or RACH occasions for the preamble transmission when the indication indicates the TRP is the first TRP or the second TRP.

The WTRU may receive a RAR in response to the preamble transmission that may include a TA or TA adjustment. The WTRU may apply the TA or TA adjustment to the TRP (e.g., to an UL transmission to the TRP) that was indicated in the request (e.g., the PDCCH order).

The WTRU may receive a PDCCH that schedules a PDSCH that carries a RAR. The PDCCH may include an indication that may indicate (e.g., using a beam indication or TCI state) the first TRP and/or the second TRP. The WTRU may receive the PDSCH using the indicated beam or TCI state. The WTRU may determine the TRP to which the RAR applies based on the indicated beam or TCI state. The RAR may include a TA or TA adjustment. The WTRU may apply the TA or TA adjustment to the TRP (e.g., to an UL transmission to the TRP) that was indicated by the PDCCH scheduling the RAR.

When the PDCCH that schedules the PDSCH carrying the RAR indicates the TRP associated with the RAR, the PDCCH order may not include a TRP indication.

### TA Determination Based on Measurements

The WTRU may obtain a TA (or TA adjustment) for a first TRP using a random access procedure. The WTRU may measure or determine the time difference between receptions from the first and second TRP and use that time difference to determine the TA or a TA adjustment to use for the second TRP.

For example, the WTRU may measure or determine a time difference, such as a time difference of arrival (TDOA) between a signal or channel received from the first TRP and a signal or channel received from the second TRP. A signal or channel may be a sync signal such as PSS or SSS or a reference signal such as CSI-RS or DM-RS. A signal or channel may be a SS/PBCH block which may include PSS, SSS, and/or PBCH.

The WTRU may receive an indication, e.g., from the gNB, indicating what signals or channels to use for the measurements or determinations. For example, the WTRU may receive an indication or configuration of a first CSI-RS associated with the first TRP and an indication or configuration of a second CSI-RS associated with a second TRP. The WTRU may use the first CSI-RS and the second CSI-RS to measure or determine a time difference. The WTRU may use the measured or determined time difference to determine the TA for the second TRP. The WTRU may determine the TA for the second TRP from the TA for the first TRP and the measured or determined time difference.

The WTRU may send the time difference measurement to the gNB.

### TA Update Using MAC-CE

A WTRU may receive a TA command, for example in a MAC-CE. The WTRU may receive a TA command from a gNB. The TA command may provide a TA adjustment.

The TA command may include an indication of the TRP to which the TA command applies. The indication may be or may include an ID such as a cell ID (e.g., an index identifying a cell or cell ID), a beam indication, and/or a TCI state. A cell ID may be a physical cell ID.

The WTRU may apply the TA or TA adjustment to the TRP (e.g., to an UL transmission to the TRP) that was indicated by the TA command.

The WTRU may receive a PDCCH that schedules a PDSCH that carries a TA command MAC-CE. The PDCCH may include an indication that may indicate (e.g., using a beam indication or TCI state) the first TRP and/or the second TRP. The VVTRU may receive the PDSCH using the indicated beam or TCI state. The WTRU may determine the TRP to which the TA Command applies based on the indicated beam or TCI state. When the MAC-CE includes a TA or TA adjustment, the WTRU may apply the TA or TA adjustment to the TRP (e.g., to UL transmission to the TRP) that was indicated by the PDCCH scheduling the PDSCH carrying the TA Command MAC-CE.

The WTRU may receive a TA command that includes a TA or TA adjustment for a first TRP and a second TRP. The WTRU may apply the respective TA or TA adjustment to the respective TRP (e.g., to respective UL transmissions to the TRPs).

### Timing Advance Group (TAG)

One or more serving cells may be associated with a TAG. The serving cells in a TAG may use the same timing reference cell. The timing reference cell may be a serving cell within the TAG.

One or more of the serving cells in a TAG may be associated with a supplementary cell (e.g., non-serving cell), for example for multi-TRP operation.

The supplementary cells associated with the serving cells in a first TAG may be associated with a second TAG which may be a supplementary (e.g., non-serving) TAG. The reference cell for a supplementary TAG timing may be one of the supplementary cells in the supplementary TAG.

When the WTRU receives a TA or TA adjustment such as in a TA command or an RAR and the TA or TA adjustment is indicated to be for a supplementary (e.g., non-serving) TRP, the TA or TA adjustment may apply to the supplementary (e.g., non-serving) cells in a supplementary TAG, e.g., the indicated supplementary TAG or the TAG of the indicated supplementary (e.g., non-serving) cell.

When TAG x is indicated and the TA or TA adjustment is for the supplementary/non-serving TRP, the TA or TA adjustment may apply to the supplementary (e.g., non-serving) cells that are associated with the serving cells in TAG X.

Timing Advance Relation with TAG (Timing Advance Groups), TCI States and CORESETs

One or more groups of timing advance may be used or configured, and each timing advance group (TAG) may be associated with a timing advance value (NTA_New), wherein the timing advance value may be updated based on an indication from the gNB. For example, a first TA value associated with a first TAG (e.g., NTA_New,1) may be updated when a TA command (TAC) associated with the first TAG is received; a second TA value associated with a second TAG (e.g., NTA_New,2) may be updated when a TAC associated with the second TAG is received.

Timing advance value may be updated based on TAC (e.g., TA command). For example, NTA_New=NTA_Old+TA_command, wherein NTA_Old may be a previous TA value (e.g., latest TA value) and TA_command is TA update value (e.g., TAC) indicated from gNB.

A TAC may be indicated with a TAG identity (TAG-id).

A TAG identity may be associated with at least one of cell group (e.g., MCG, SCG), carrier index, bandwidth part identity, subband index, TRP index, and/or physical cell identity.

Hereafter, the term TAG may be interchangeably used with TAG-id, TAG-identity, TA value, TA command value, TA command.

Uplink, downlink, and sidelink also may be used interchangeably.

### Relation of the TCI State, the Uplink Resources, and TAG

In an embodiment, a TCI state (or spatial relation info, SRS resource indicator/index) may be associated with a TAG. For example, when a TCI state is configured, an associated TAG information (e.g., TAG-id) may be configured. When a WTRU received an uplink grant with a TCI state (or spatial relation info) for the uplink transmission, the WTRU may apply, use, or determine a TA value based on the associated TAG information for the TCI state (or spatial relation info, SRS resource indicator/index). One or more of following may apply:
A TCI state and spatial relation info may be used to indicate an uplink beam to use for an uplink transmission granted. TCI state, SRS resource indicator/index (SRI), and spatial relation info may be interchangeably used.
A two-stage TCI state indication may be used. For example, in a first stage, a TAG-id may be indicated to determine TA value for an uplink grant and the indicated TAG-id may determine a set of TCI states; in a second stage, a TCI state indication bit field may indicate a TCI state within the set of TCI states determined based on the TAG-id indicated
The TCI state associated with a TAG (or TAG-id) may be a TCI state of at least one of
   A TCI state configured for a CORESET which may be associated with the PDCCH search space in which a WTRU may receive an uplink grant
   A TCI state indicated in an uplink grant (e.g., DCI format 0-0, 0-1)
   A TCI state configured for a PUCCH transmission
A serving cell identity (e.g., servingCellId) configured for a spatial relation info (e.g., for PUCCH and SRS) may be associated with a TAG (or TAG-id). For example, a WTRU may determine TAG (or TAG-id) based on the serving cell identity associated with a spatial relation info determined for PUCCH or SRS transmission
   Relation of Beam Reference Signals RS, Pathloss with TAG

In an embodiment, a beam reference signal (e.g., SSB, CSI-RS, TRS, or SRS) may be associated with a TAG. For example, a TAG (or TAG-id) may be associated with a pathloss reference RS which may be used for pathloss measurement for uplink power control (e.g., open-loop power control).

A pathloss reference RS may be configured with a TAG-id.

### Relation Between CORESET(s) and TAG

In an embodiment, a TAG-id for an uplink transmission may be determined based on a CORESET (or a search space, search space parameters) in which a WTRU received the uplink grant. For example, a WTRU may receive an uplink grant (e.g., DCI format for uplink grant, DCI format 0-0, 0-1) in one or more PDCCH search spaces, wherein each PDCCH search space may be associated with, or configured with a TAG-id. The association between PDCCH search space and TAG-id may be based on the corresponding CORESET for the PDCCH search space. One or more of following may apply:
A CORESET may be configured with a TAG-id, and all PDCCH search spaces associated with the CORESET may use the same TAG-id configured for the CORESET
   A CORESETPoolId may be configured with a TAG-id. For example, a TAG-id may be determined, configured, or indicated for a CORESETPoolId. Therefore, an associated TAG-id for a CORESET may be determined based on the CORESETPoolId used, configured, or determined for the CORESET
A search space may be configured with a TAG-id
A TAG-id may be determined based on search space related parameters for the uplink DCI received including at least one of CCE aggregation level, PDCCH candidate, PDCCH candidate index, and RNTI

### Relation of Target Receiver Identity and a TAG-Id

In an embodiment, a TAG-id for an uplink transmission may be determined based on an identity of the target receiver of the transmission. At least one of following may be used or determined as an identity of the target receiver:
Serving cell identity which may be configured with a spatial relation info, CORESET, TCI state, PDCCH search space, and/or bandwidth part
Source or destination identity for a sidelink transmission
TRP index
TCI state

### Time Alignment Timer

A WTRU may maintain a separate time alignment timer (TAT) for a first TRP and a second TRP where the first TRP may be a serving TRP and the second TRP may be a supplementary (e.g., non-serving) TRP.

For example, the WTRU may maintain a first TAT for a first TAG and a second TAT for a second TAG. The cells associated with the first TAG may be serving cells. The serving cells may be associated with a first TRP that may be a serving TRP. The cells associated with the second TAG may be supplementary (e.g., non-serving) cells and may be associated with a second TRP that may be a supplementary (e.g., non-serving) TRP. The supplementary (e.g., non-serving) cells may be associated with (e.g., configured as supplementary cells for) at least some of the serving cells in the first TAG.

The WTRU may start or restart the first TAT when the WTRU receives a TA command for the first TAG. The WTRU may start or restart the second TAT when the WTRU receives a TA command for the second TAG.

When the first TAT expires, the WTRU may stop or expire the second TAT.

When the second TAT expires, the WTRU may send a message or indication (e.g., to the gNB) to indicate that the second TAT has expired.

When a TAT associated with the second TRP or a TAT associated with a TAG of the second TRP has stopped or has expired, the WTRU may send a message or indication to the gNB to indicate that the TAT has stopped or has expired or that the WTRU is not UL time aligned with the second TRP. The WTRU may include in or with the message or indication an indication of the TAG and/or TRP to which the indication applies.

When the second TAT expires, the WTRU may use time difference measurements between the first TRP and the second TRP combined with the TA for the first TRP to determine a TA to use for the second TRP (e.g., for one or more cells of the second TRP).

When a TAT for a TAG is running or not expired, the WTRU may transmit in the UL on the cells (which may be serving or supplementary/non-serving cells)

When a TAT for a TAG is not running or is expired, the WTRU may not transmit in the UL on the cells (which may be serving or supplementary/non-serving cells)

### 5.5 Beam Application Time

In dynamic TCI state indication, a new TCI state from a configured pool may be indicated by L1/L2 signaling. In an L1-based indication, the indicated TCI state may be indicated by a DCI. The DCI may be a WTRU specific or group common DCI. Furthermore, it may be a dedicated DCI for TCI state indication, or a DCI carrying a TCI state plus other information, e.g., scheduling information, etc.

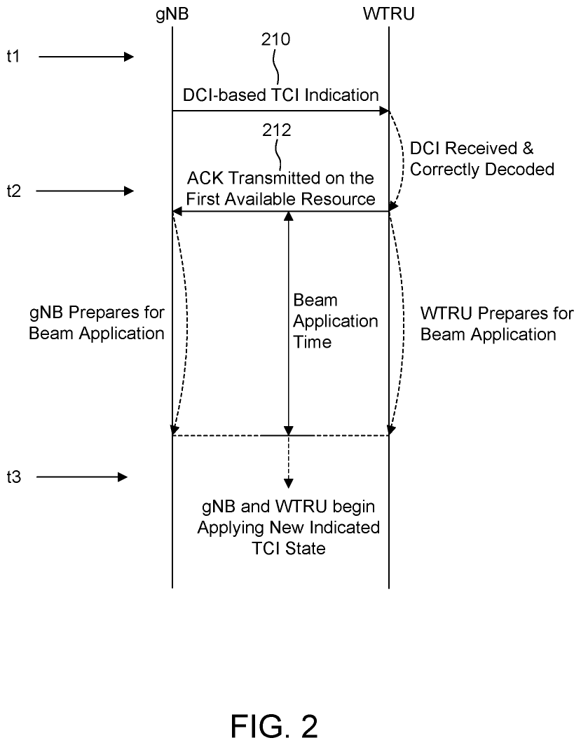

A WTRU may acknowledge reception of the indicated TCI by transmission of an uplink signal, e.g., ACK, SRS, etc. To make sure that both the WTRU and the gNB are in sync in application of the newly indicated TCI state, they may use a same time reference, e.g., a reference associated with the transmission of the acknowledgment signal. The beam application time for an indicated TCI refers to the time elapsed from a time reference point known to both the gNB and the WTRU (e.g., the last symbol of the transmitted acknowledgment signal, or the received PDCCH including the DCI for indication of TCI state) to the time of application of the new TCI state. As such, both the gNB and the WTRU may apply the newly indicated TCI state after applying the beam application time. FIG. 2 is a signal flow diagram illustrating an exemplary case of a dynamic indication of TCI state by a DCI and utilization of beam application time. While FIG. 2 demonstrates the process assuming the ACK as the reference point in time, a similar process can be implemented by assuming reception of the PDCCH that carries the DCI for indication of the TCI state as the point of reference.

As shown, at time t1, the gNB sends a DCI-based TCI indication 210 to the WTRU. The TCI indication includes a beam application time. The WTRU receives and decodes the TCI indication and, at time t2, transmits an acknowledgement 212 of the TCI indication back to the gNB. Then, both the gNB and the WTRU wait the specified beam application time (in this example, until time t3) to apply the new TCI state.

The resources for the transmission of the acknowledgment signal 212 may be a set of preconfigured resources or may be indicated implicitly or explicitly by the received DCI. In an implicit indication, different resource indices may be associated with one or more of search space, CORESET, DCI type, an RNTI, cell index, slot number, etc.

The beam application time may be configured by the gNB. The configured application time may be greater than or equal to the beam switching time capability reported by the WTRU. A gNB may decide on the value of the beam application time based on one or more of:
gNB's beam update delay,
beam switching time capability of one or more WTRUs,
gNB, WTRU processing times,
configured TDD pattern,
availability of acknowledgment resources, e.g., PUCCH, SRS resources,
PDCCH resources and WTRU's blind decoding capability.

In an inter-cell multi-TRP transmission, each TRP is associated with a serving and non-serving cell wherein each is identified with its own cell ID. In an inter-cell multi-TRP transmission, a WTRU may be configured with different TCI states and QCL information according to each cell.

In a single-DCI inter-cell multi-TRP transmission, a WTRU may receive a single dynamic signaling, e.g., a DCI, to indicate a new pair of TCI states associated with the TRPs. The received DCI may include more than one TCI field to indicate a pair of the updated TCI states.

In a multi-DCI inter-cell multi-TRP transmission, a WTRU may receive more than one dynamic signaling, e.g., a DCI, each indicating an updated TCI state for the corresponding TRPs. The received DCI may include a single TCI field to indicate the updated TCI states.

In an inter-cell multi-TRP transmission, a WTRU may receive more than one dynamic signaling, e.g., a DCI; each indicating an updated TCI state for the corresponding TRPs.

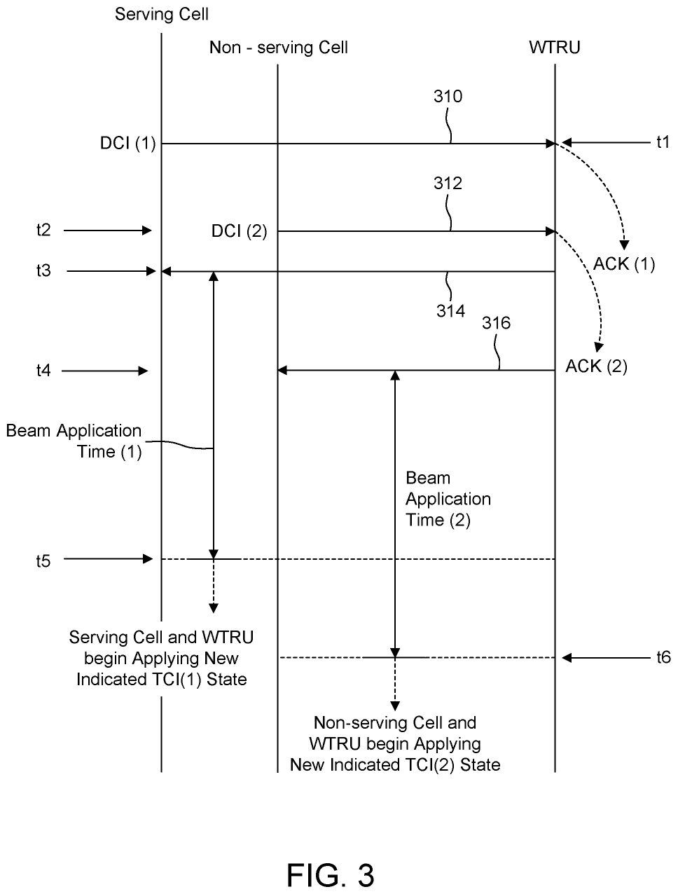

FIG. 3 is a signal flow diagram illustrating an embodiment wherein a WTRU may send separate acknowledgment signals for each dynamically indicated TCI state. Then, the WTRU may utilize the configured beam application times separately based on each transmitted acknowledgement signal.

Referring to FIG. 3, the serving cell sends a first DCI based TCI indication 310 at time t1 including a first beam application time indicator and the second, non-serving cell sends a second DCI based TCI indication 312 at time t2 including a second beam application time indicator. The first and second beam application times may be the same or different. The WTRU acknowledges the first TCI Indication (314) at time t3 and acknowledges the second TCI indication (316) at time t4. Then, the serving cell and the WTRU apply the first TCI state starting at the first beam application time delay after time t3 (i.e., time t5). The second, non-serving cell and the WTRU apply the second TCI state starting at the second beam application time delay after time t4 (i.e., time t6).

In an embodiment, a WTRU may be configured with a time duration X; measured in a number of symbols, slots, etc.
If a WTRU receives a second dynamically indicated TCI state within the time window X started from the first dynamically indicated TCI state, the WTRU may send only one ACK to the single gNB supporting both cells if both indicated TCI states are decoded correctly. In an embodiment, a WTRU may utilize the configured beam application times according to the single transmitted acknowledgement signal.
If a WTRU does not receive a second dynamically indicated TCI state within the time window X started from the first dynamically indicated TCI state, WTRU may send an acknowledgment per correctly decoded TCI state. Then, in an embodiment, a WTRU may utilize the configured beam application times separately based on each transmitted acknowledgement signal.

In an embodiment, in an inter-cell multi-TRP transmission, a WTRU may receive one or more beam application times.

A WTRU may be configured with more than one beam application time, wherein the individual beam application times may be associated with the serving cell and the non-serving cell, respectively. In an inter-cell multi-TRP operation:
the WTRU may continue to consider the first beam application time value to be associated with the serving cell and the second beam application time value to be associated with the non-serving cell
the WTRU may consider the larger of the two beam application time values as the beam application time
the WTRU may utilize a single beam application time value.

In an embodiment, a WTRU may determine the applicability of a beam application time based on one or more of the followings:
A WTRU may determine the applicability of a configured beam application time based on whether the received DCI is from the serving cell or non-serving cell. For example, reception of a DCI from the serving cell indicates utilization of a first beam application time, and reception of a DCI from the non-serving cell indicates utilization of a second beam application time.
A WTRU may determine the applicability of a configured beam application time based on an implicit or explicit indication in the received DCI, e.g., a DCI field.
A WTRU may determine the applicability of a configured beam application time implicitly based on the indicated TCI/QCL information. If the indicated TCI/QCL information is associated with a serving cell, it may indicate utilization of a first configured value, and if the indicated TCI/QCL information is associated to a non-serving cell, it may indicate utilization of a second configured value. A WTRU may determine the applicability of a configured beam application time implicitly based on the indicated source reference signal in TCI/QCL information. If the indicated source reference signal in TCI/QCL information is associated with a serving cell, it may indicate utilization of a first configured value, and if the indicated source reference signal in TCI/QCL information is associated with a non-serving cell, it may indicate utilization of a second configured value.

### 5.6 PCI and CORESET Pool Index (CORESETPoolIndex)

A WTRU may be configured with information related to one or more of its neighboring cells. For example, the information may include cell index information, synchronization signal block (SSB) parameters, TCI/QCL information, etc. If a WTRU is configured by higher layer parameter PDCCH-Config that includes two different values of CORESETPoolIndex in CORESET, the WTRU may expect to receive multiple PDCCHs transmissions in the corresponding configured CORESETs.

In an embodiment, a WTRU may determine whether the received PDCCHs are from the same cell, e.g., intra-cell, or from two different cells, e.g., inter-cell, by detecting the association of CORESETPoolIndex values.
In an embodiment, if CORESETPoolIndex value may take only from two values, e.g., {0, 1}, one of CORESETPoolIndex value, e.g., 0, may be always associated to a first PCI or serving cell, while the other value, e.g., 1, may be associated to one or more of PCI values that may be the serving cell or one of the neighboring cells.
A WTRU may receive an indication to switch between inter-cell mTRP operation and intra-cell mTRP operation. The indication may be received and transmitted (or otherwise provided/exchanged) on any of a dynamic and semi-static basis, and any of L1, L2 and higher layer control signaling/transmission and/or channel transmissions, including, for example, any of DCI, MAC CE and RRC signaling/transmissions.
   The indication may be used to determine the PCI associated to the CORESETPoolIndex. In an embodiment, by receiving an indication, a WTRU may determine whether the CORESETPoolIndex=1 is referring to an intra- or inter-cell.
      The indication may be explicit, for example, by indication of an information element that may be directly associated to a PCI.
      For example, a new indicator with log 2(X) bits may be used to indicate which of the X neighboring cell is considered for inter-cell operation. Then, indication or presence of this information element may indicate that a CORESETPoolIndex=1 is referring to an inter-cell TRP.
      In another example, indication of any X value except an specific value, e.g., X≠0, may indicate that CORESETPoolIndex=1 is referring to an inter-cell operation.
   In an embodiment, the indication may be implicit, e.g., by indication or activation of TCIs associated to another PCIs.
      For example, if a WTRU may receive a dynamic or semi-static command for activation of a subset of TCI states that are configured for a neighbor cell, a CORESETPoolIndex=1 may be referring to an inter-cell operation.
      In another example, if a WTRU receives a dynamic or semi-static indication, (e.g., a DCI indicating a TCI configuration for transmission where the indicated TCI is associated to a neighboring cell), a CORESETPoolIndex=1 may be referring to an inter-cell operation.

In an embodiment, a WTRU may determine the PDCCH configurations for mTRP operation according to the received explicit or implicit indication of PCI. In an embodiment, a WTRU may receive at least one PDCCH configuration that may be related to at least one of its neighboring cells, (e.g., PDCCH-config_neighbor). The PDCCH-config_neighbor may include information such as CORESET and search space information required for the decoding of PDCCH of the neighboring cell.
In an embodiment, a PDCCH-config_neighbor may have an index and may be associated to one or more PCIs.

In an embodiment, a WTRU may determine some of information related to PDCCH of the neighboring cell, e.g., CORESET, search space information, etc., from PDCCH configuration of the serving cell, e.g., PDCCHconfig.
Information of the neighboring cell, such as CORESET, search space, etc., may be flagged by a new identification index that may be associated to the PCI of a neighbor cell. In an embodiment, they may be indicated by new set of parameters in the serving cell PDCCH configuration (e.g., ControlResourceSet_neighbor, SearchSpace_neighbor, etc.).
In an embodiment, a WTRU may determine the PDCCH configurations for inter-cell mTRP operation by grouping the list of a given configuration where one group may be associated for intra-cell and another group may be for inter-cell mTRP operation.
For example, for controlResourceSetToAddModList configuration in PDCCH-config, the range may be extended from 3 to 9. Then, a WTRU may determine a CORESET for a first and second neighbor cell by indices >3 and >7, respectively. For example, controlResourceSetToAddModList={1, 4, 8} may indicate CORESET 1, 4 and 8 for the serving cell, first neighbor cell and second neighbor cell, respectively.

The TCI state configuration may include an index or an indicator that may be used to discriminate the serving cell related TCI states from those of intra-cell mTRP and inter-cell TRP. Using this information the following embodiments can be envisioned:

In an embodiment, it is proposed that at any moment, only intra-cell mTRP or inter-cell mTRP may operate, thus there is no simultaneous intra-cell and inter-cell mTRP operation.

Under this scenario, as TCI states may be activated by MAC, the gNB may decide which mTRP will operate by TCI state activation. Thus, if the intra-cell TCI states are active, then the WTRU may use CORESETPoolIndex 1 for intra-cell mTRP using the corresponding QCL assumption associated to the PCI of the serving cell and RSs related to the intra-cell TRP. If the inter-cell related TCI states (that are known by index or cell PCI indicator) are activated, the WTRU may use CORESETPoolIndex 1 for inter-cell mTRP reception using the correct QCL indicated by the appropriate active TCI state. It is understood that the intra-cell vs. inter-cell TRP switching using MAC TCI activation mechanism described above may have a certain latency derived from MAC operation level.

### Wtru Behavior:

If the WTRU receives a MAC CE TCI activation command on its serving cell including the TCI state(s) related to the intra cell TRP(s), it may first acknowledge the MAC CE reception/decoding sending an ACK to the serving cell and then start monitoring PDCCH on CORESET POOL Index 1 with the new TCI states assumption for intra-cell TRP. The MAC CE command may explicitly deactivate the TCI state(s) for inter-cell related TRP.

In an embodiment, the WTRU may deactivate inter-cell TCI state(s) automatically when the intra-cell TCI states are activated. The inter-cell to intra-cell switch states may work the same way.

Into another MAC CE embodiment, both intra-cell and inter-cell TCI states are activated at the same time, and have a different MAC CE command as a flag or indicator for the intra-cell or inter-cell CORESET Pool Index association assumption. Upon receiving a such MAC CE command, the WTRU may acknowledge the MAC CE reception, and in the next slot may start monitoring PDCCH with the correct CORESET Pool Index association with the correct TCI state assumption.

In an embodiment, it is proposed to reduce the switching time latency such that the operation may be driven at the slot level granularity.

The intra-cell and inter-cell TRP related TCI states may be activated at the same time by MAC. The CORESETPoolIndex 1 usage in slot n may be indicated by a DCI order that may be received on the serving cell in slot n−1, as the intra-cell or inter-cell mTRP reception may happen in slot n according to the DCI order that drives the pick of the correct QCL given by a corresponding active TCI state mapped to the DCI order for the CORESETPoolIndex 1 association.

As an example, the number of inter-cell PCIs may be 1 and can go up to 7. A DCI order may be a group of 3 bits. A mapping between the 3 bits in the DCI order an activated TCI states related to these inter-cell mTRP PCIs may be possible. For example a direct mapping for DCI order number and corresponding TCI or TCI group states for a specific PCI can be created or configured by RRC as an enumeration. For example, when DCI order is “000” it may signal that Intra-cell mTRP is associated with CORESETPoolIndex 1.

If the DCI order is different than “000”, then CORESETPoolIndex 1 may be associated with the mapped number for PCI related TCI state or TCI state group.

WTRU behavior: Upon reception of the DCI command on its serving cell, the WTRU may acknowledge the reception and in the next slot or next downlink transmission symbol start monitoring the PDCCH with the correct CORESET Pool Index association. In an embodiment, the DCI command may not require WTRU acknowledgement. In this case, the WTRU may start monitoring PDCCH with the correct CORESET Pool index 1 association in the next downlink PDCCH occasion.

In an embodiment, it is proposed to increase the number of RRC configured CORESET Pools beyond 2. In this particular situation a MAC CE command may be used to activate one or more CORESET Pool Indexes that may be associated to a certain inter-cell mTRP PCI or PCI group. This maximum number of active CORESET Pools may be a WTRU capability.

In this scenario, the TCI states that may already correctly discriminate the related PCI QCL information, may be mapped to a CORESETPoolIndex by RRC. Thus when a certain CORESETPoolIndex is activated the WTRU may consider automatically the associated active TCI state for that particular PCI, and thus the correct CORESETPoolIndex may be used.

In an embodiment, if the RRC mapping for CORESETPoolIndex and PCI is configured, the activation of a TCI state that belongs to a certain PCI, the correct CORESETPoolIndex may be directly inhered by the WTRU.

In an embodiment, the CORESETPoolIndex activation may be sent through a DCI order on the serving cell.

Upon reception of such order in slot n−1, the WTRU may analyze the mapping of the PCI with the CORESETPoolIndex i and according to the activated TCI states of the PCI, may start decoding the PDCCH in the correct CORESETPool with the correct QCL assumptions in slot n.

In an embodiment, one or more inter-cell PCIs (e.g., up to 7 inter-cell PCIs) configured to a WTRU may be associated with one or more CORESETPoolIndex(es), e.g., by RRC signaling when the one or more inter-cell PCIs are configured to the WTRU. In various embodiments, a first inter-cell PCI (of the one or more inter-cell PCIs) may be associated with (Candidate-)CORESETPoolIndex 1 (of the one or more CORESETPoolIndex(es)), and a second inter-cell PCI may be associated with (Candidate-)CORESETPoolIndex 2, and a third inter-cell PCI may be associated with (Candidate-)CORESETPoolIndex 3, and a fourth inter-cell PCI may be associated with (Candidate-)CORESETPoolIndex 4, and so on.

The WTRU may receive a separate/independent plurality of TCI-states (e.g., TCI state pool) for each of the one or more CORESETPoolIndex(es). In various embodiments, a first plurality of TCI-states (e.g., a first TCI state pool) may be configured as being associated with the first inter-cell PCI and/or the (Candidate-)CORESETPoolIndex 1, a second plurality of TCI-states may be configured as being associated with the second inter-cell PCI and/or the (Candidate-)CORESETPoolIndex 2, a third plurality of TCI-states may be configured as being associated with the third inter-cell PCI and/or the (Candidate-)CORESETPoolIndex 3, a fourth plurality of TCI-states may be configured as being associated with the fourth inter-cell PCI and/or the (Candidate-)CORESETPoolIndex 4, and so on.

The WTRU may receive an indication (e.g., via a MAC-CE) activating (e.g., down-selecting) a subset of the one or more CORESETPoolIndex(es), where each of the subset of the one or more CORESETPoolIndex(es) may be (re-)mapped (e.g., re-numbered) to a codepoint pointing to a CORESETPoolIndex in a TCI state activation MAC-CE message. In various embodiments, the WTRU may determine the subset of the one or more CORESETPoolIndex(es) comprises the (Candidate-)CORESETPoolIndex 2 and the (Candidate-)CORESETPoolIndex 4. In response to the determining, the WTRU may identify (e.g., determine) 3 different codepoints for indicating CORESETPoolIndex(es) in the TCI state activation MAC-CE message. A first codepoint of the 3 different codepoints may indicate CORESETPoolIndex 0 (which may be fixed as a default codepoint, e.g., associated (always) with a serving-cell PCI). A second codepoint of the 3 different codepoints may indicate the (Candidate-)CORESETPoolIndex 2 (which may be re-numbered to CORESETPoolIndex 1 for further signaling usage, e.g., being mapped to a TCI field in a DCI, etc.). A third codepoint of the 3 different codepoints may indicate the (Candidate-)CORESETPoolIndex 4 (which may be re-numbered to CORESETPoolIndex 2 for further signaling usage, e.g., being mapped to a TCI field in a DCI, etc.). This may mean a field size of the field indicating CORESETPoolIndex(es) in the TCI state activation MAC-CE message may be varying based on the indication activating (e.g., down-selecting) a subset of the one or more CORESETPoolIndex(es).

In various embodiments, the WTRU may receive a first TCI state activation MAC-CE message indicating the second codepoint (which points to the (Candidate-)CORESETPoolIndex 2 associated with the second plurality of TCI-states). In response to receiving the first TCI state activation MAC-CE message, the WTRU may determine (e.g., identify) indicated/activated first TCI-state(s) in the first MAC-CE message are among the second plurality of TCI-states, e.g., (all) associated with the second inter-cell PCI.

In various embodiments, the WTRU may receive a second TCI state activation MAC-CE message indicating the third codepoint (which points to the (Candidate-)CORESETPoolIndex 4 associated with the fourth plurality of TCI-states). In response to receiving the second TCI state activation MAC-CE message, the WTRU may determine (e.g., identify) indicated/activated second TCI-state(s) in the second MAC-CE message are among the fourth plurality of TCI-states, e.g., (all) associated with the fourth inter-cell PCI.

### 5.7 Example of a Method Implemented in a WTRU for Multi-TRP CSI Reporting

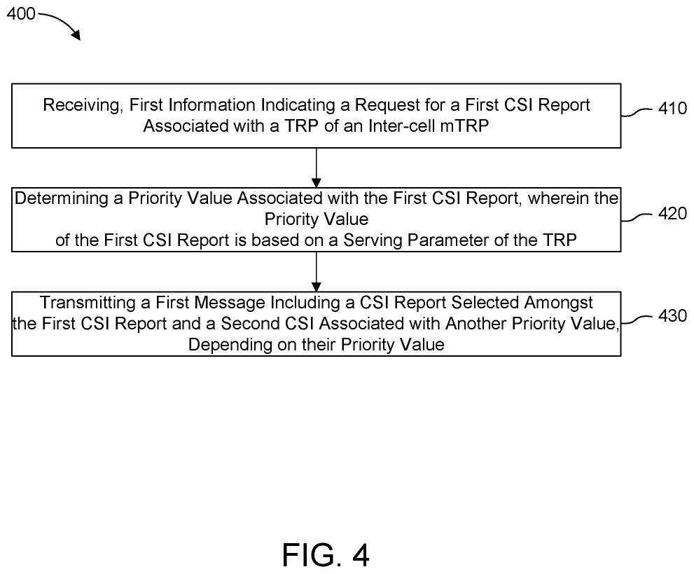

Referring to FIG. 4, a method 400 implemented in a WTRU may comprise a step of receiving 410, (e.g., from a network node), first information indicating a request for a first report on state information of a first channel (e.g., a first CSI report) associated with a TRP of an inter-cell multi transmission reception point configuration (mTRP). In such context, the WTRU may determine that a transmission of a second message including the first report on state information of the first channel would overlap (e.g., collide) with a transmission of a third message including a second report on state information of the second channel. The WTRU may determine 420 a (e.g., specific) a priority value associated with the first report on state information of the first channel, wherein the priority value of the first report on state information of the first channel is based on a serving parameter (e.g., feature) of the transmission-reception point. The serving parameter may indicate whether the first transmission reception point is a serving cell or a non-serving cell such that on condition that the TRP is a serving cell, the priority value of the first report on state information of the first channel may be determined based on an offset that is a first value, and on condition that the transmission reception point is a non-serving cell, the priority value of the first report on state information of the first channel may be determined based on an offset that is a second value that differs from the first value.

More particularly, the priority value of the first report on state information of the first channel may be determined based on a sum of a cell index of the transmission reception point and an offset determined based on whether the transmission reception point corresponds to a serving cell or a non-serving cell (e.g., offset=0 for serving cell, 1 for non-serving cell). In addition, the priority value of the first report on state information of the first channel may be determined such that the priority value, when the TRP is the non-serving cell, is equal to the priority value when the TRP is the serving cell plus the offset (e.g., offset=1).

In order to avoid overlapping (e.g., collision), the method may comprise a step wherein the WTRU may transmit 430, (e.g., to the network node), a first message including a report on state information of a channel selected amongst the first report on state information of the first channel and the second report on state information of the second channel associated with (e.g., another) priority value, depending on their priority value. As an example, the WTRU may transmit the first message including the report on state information of a channel that has the lower priority value. The non-selected report on state information of a channel may be dropped.

In the context of the invention, the determination of a priority value to the first report on state information of the first channel may be determined form an extended function of the current priority function defined in Rel-16. Such assignment may provide a priority value to the first report on state information of the first channel that differs from the priority value of the second report on state information of the second channel that may have been determined form the current Rel-16 priority function. In other words, according to one embodiment, on condition that a transmission of a first CSI report would collide with the transmission of a second CSI report, the WTRU may determine a priority value for the first CSI report based on a cell index of the TRP and whether the TRP corresponds to a serving cell or a non-serving cell and transmitting the CSI report from among the first and second CSI reports that has a lower priority value.

### 6. Conclusion

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, WTRU, terminal, base station, RNC, or any host computer.

Moreover, in the embodiments described above, processing platforms, computing systems, controllers, and other devices including processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. In an embodiment, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. A group having 1-3 cells may refer to groups having 1, 2, or 3 cells. Similarly, a group having 1-5 cells may refer to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. § 112, ¶6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1-18. (canceled)

19. A method implemented in a wireless transmitter/receiver unit (WTRU) the method comprising:
receiving, from a network node, a first message comprising configuration information for a serving cell, wherein the configuration information indicates a plurality of timing advance groups (TAGs) and a plurality of transmission configuration indication (TCI) states, and wherein each TCI state is associated with a timing advance group (TAG) of the plurality of TAGs;
transmitting, to the network node, a preamble on a physical random access channel transmission;
in response to transmitting the preamble, receiving, from the network node, a random access response message comprising information indicating a timing advance (TA) value and a TAG identity associated with a first TAG of the plurality of TAGs;
receiving, from the network node, a physical downlink control channel (PDCCH) indicating information comprising a TCI state identity associated with a first TCI state of the plurality of TCI states; and
transmitting an uplink (UL) transmission, wherein a timing of the UL transmission is adjusted based on the received TA value when the first TCI state of the plurality of TCI states is associated with the first TAG.

20. The method of claim 19, wherein the serving cell is associated with a first transmission/reception point, TRP.

21. The method of claim 20, wherein the first TAG is associated with the first TRP.

22. The method of claim 20, wherein the first TCI state is associated with the first TRP.

23. The method of claim 20, wherein the serving cell is associated with the first TRP and a second TRP.

24. The method of claim 23, wherein the first TRP and the second TRP operate using a first bandwidth (BW) and a second BW, respectively, and wherein center frequencies of both the first and second BWs are the same.

25. The method of claim 23, wherein the first TRP and the second TRP are associated with a same physical cell identity.

26. The method of claim 23, wherein a second TAG different from the first TAG is associated with the second TRP.

27. The method of claim 19, wherein the information indicated by the PDCCH includes scheduling information for the UL transmission.

28. The method of claim 19, wherein the plurality of TAGs is associated with the serving cell.

29. A wireless transmit/receive unit (WTRU) comprising a processor, a transceiver unit and a storage unit, and configured to:
receive, from a network node, a first message comprising configuration information for a serving cell, wherein the configuration information indicates a plurality of timing advance groups (TAGs) and a plurality of transmission configuration indication (TCI) states, and wherein each TCI state is associated with a timing advance group (TAG) of the plurality of TAGs;
transmit, to the network node, a preamble on a physical random access channel transmission;
in response to transmit the preamble, receive, from the network node, a random access response message comprising information indicating a timing advance (TA) value and a TAG identity associated with a first TAG of the plurality of TAGs;
receive, from the network node, a physical downlink control channel (PDCCH) indicating information comprising a TCI state identity associated with a first TCI state of the plurality of TCI states; and
transmit an uplink (UL) transmission, wherein a timing of the UL transmission is adjusted based on the received TA value when the first TCI state of the plurality of TCI states is associated with the first TAG.

30. The WTRU of claim 29, wherein the serving cell is associated with a first transmission/reception point, TRP.

31. The WTRU of claim 30, wherein the first TAG is associated with the first TRP.

32. The WTRU of claim 30, wherein the first TCI state is associated with the first TRP.

33. The WTRU of claim 30, wherein the serving cell is associated with the first TRP and a second TRP.

34. The WTRU of claim 33, wherein the first TRP and the second TRP operate using a first bandwidth (BW) and a second BW, respectively, and wherein center frequencies of both the first and second BWs are the same.

35. The WTRU of claim 33, wherein the first TRP and the second TRP are associated with a same physical cell identity.

36. The WTRU of claim 33, wherein a second TAG different from the first TAG is associated with the second TRP.

37. The WTRU of claim 29, wherein the information indicated by the PDCCH includes scheduling information for the UL transmission.

38. The WTRU of claim 29, wherein the plurality of TAGs is associated with the serving cell.
